(19) United States
(12) Patent Application Publication
(10) Pub. No.: US 2019/0006748 A1
(43) Pub. Date: Jan. 3, 2019

(54) ANTENNA APPARATUS INCLUDING LENS AND COMMUNICATION METHOD USING LENS ANTENNA

(71) Applicant: KOREA ADVANCED INSTITUTE OF SCIENCE AND TECHNOLOGY, Daejeon (KR)

(72) Inventors: Dong-Ho CHO, Daejeon (KR); Yun-Sik KIM, Daejeon (KR); Lakju SUNG, Daejeon (KR); Sangmi NOH, Daejeon (KR)

(21) Appl. No.: 16/006,113

(22) Filed: Jun. 12, 2018

(30) Foreign Application Priority Data
Jun. 30, 2017 (KR) 1020170083083

(51) Int. Cl. H01Q 1/52; H01Q 15/02; H01Q 21/24

(52) U.S. Cl. CPC H01Q 1/523; H01Q 21/24; H01Q 15/02

(57) ABSTRACT

A lens antenna apparatus includes a plurality of antenna units and a lens structure configured to change a phase of an electromagnetic wave, emitted by at least one antenna unit among the plurality of antenna units. The lens structure changes the phase such that the overall outputs from the plurality of antenna units have different radiation patterns.

### CROSS-REFERENCE TO RELATED APPLICATIONS

This application claims the benefit under 35 U.S.C. § 119(a) of Korean

Patent Application No. 2017-0083083, filed on Jun. 30, 2017, in the Korean Intellectual Property Office, the entire disclosure of which is incorporated herein by reference for all purposes.

### BACKGROUND

### 1. Field

The following description relates to a technology for an antenna apparatus that utilizes a lens structure.

### 2. Description of Related Art

Various techniques for increasing channel capacity in wireless communication have been studied. A traditional method of increasing the number of channels utilizes the division of time or frequency, Further, a method of increasing channel capacity using different radiation patterns or polarizations in the same frequency band was suggested. Meanwhile, various studies were conducted for obtaining improved multiple-input multiple-output (MIMO) gain using different channels.

The primary problem with an integrated antenna for MIMO gain improvement relates to a mutual coupling (mutual interference) signal between antennae in an antenna structure. Mutual coupling between antennae increases when a physical distance between the antennae decreases, and as the mutual coupling increases, each antenna experiences difficulties in transmitting an independent signal. In order to reduce mutual coupling between antennae in a MIMO antenna arrangement, a dual polarization dipole integrated antenna structure with a polarization characteristic has been suggested.

### SUMMARY

Embodiments of the invention provide an antenna apparatus including a lens. Such antenna apparatus includes a plurality of antenna units and a lens structure configured to change a phase of an electromagnetic wave produced by at least one antenna unit of the plurality of antenna units. The lens structure is configured to change the phase in such a fashion that the plurality of antenna units have different radiation patterns from each other.

Embodiments of the invention also provide a communication method utilizing the use of a lens antenna. The method includes steps of outputting or emitting, by each of the plurality of antenna units, a corresponding electromagnetic wave; allowing each of the emitted electromagnetic waves to pass through a corresponding lens structure of a plurality of lens structures; and using, as a communication channel, at least two electromagnetic waves among the electromagnetic waves the phases of which have been changed by passing through the plurality of lens structures. Lens structures from the plurality of lens structures have different refractive indexes.

Embodiments additionally provide a communication method making use of a lens antenna and including: outputting or forming, by each antenna unit of a plurality of antenna units, a corresponding initial electromagnetic wave; allowing some of the so-formed electromagnetic waves antennae to pass through a lens structure; and using, as a communication channel, at least two electromagnetic waves among the initial electromagnetic waves and the electromagnetic waves that phases of which have been changed as a result of passing through the lens structure .

### [Advantageous Effects]

The use of the following embodiments results in increase of the channel capacity of a multiple antenna system due to the use of a lens in an integrated antenna causing a reduction of a level of correlation between individual antennae. The embodiments facilitate generation of different channels with the use of the same type of antenna and contribute to effective multiple-input multiple-output (MIMO) gain on the basis of an integrated antenna having a simple structure.

### BRIEF DESCRIPTION OF THE DRAWINGS

FIG. 1 illustrates an example of a conventional 4-port integrated antenna.

FIG. 2 provides an example of a 4-port integrated antenna including a lens structure.

FIG. 3 illustrates an example of electromagnetic waves passing through a lens structure.

FIG. 4 is a graph showing a relationship between the thickness of a lens structure and a level of correlation of radiation patterns.

FIG. 5 provides a graph showing channel capacity of a 4-port integrated antenna including a lens structure.

FIG. 6 is a table analyzing a correlation level of a 4-port integrated antenna including a lens structure.

FIGS. 7A, 7B, 7C, 7D schematically illustrate a structure of a lens antenna.

FIGS. 8A, 8B illustrate the placement of a lens in a lens antenna.

FIG. 9 provides a related illustration of a placement of a lens in a lens antenna.

Throughout the drawings and the description, unless otherwise described, the same drawing reference numerals are understood to refer to the same elements, features, and structures. The relative size and depiction of these elements may be exaggerated and/or generally changed for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. Also, descriptions of well-known functions and constructions may be omitted for increased clarity and conciseness.

Meanwhile, terminology used herein will be understood as follows. Although the terms “first,” “second,” etc. may be used herein to describe various elements, these elements should not be limited by these terms. These terms are only used to distinguish one element from another. For example, a first element could be termed a second element, and, similarly, a second element could be termed a first element.

As used herein, the singular forms are intended to include the plural forms as well, unless the context indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof. It should also be noted that in some alternative implementations, the processes noted in the blocks may occur out of the order noted in the flowcharts, unless the context clearly indicates a specific order. In other words, respective processes may be executed in a specified order, executed substantially concurrently, or executed in the reverse order.

Unless otherwise defined, terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The technology described below relates to an antenna apparatus including a lens structure. The antenna apparatus descried below generally includes a plurality of antenna units. A single antenna unit emits electromagnetic waves having a specific radiation pattern. The antenna apparatus described below has a structure in which a plurality of antenna units are integrated into a single apparatus. The antenna apparatus may be a two-dimensional planar antenna or a three-dimensional planar antenna. For the sake of convenience of description, the following description will be made in relation to a two-dimensional planar antenna.

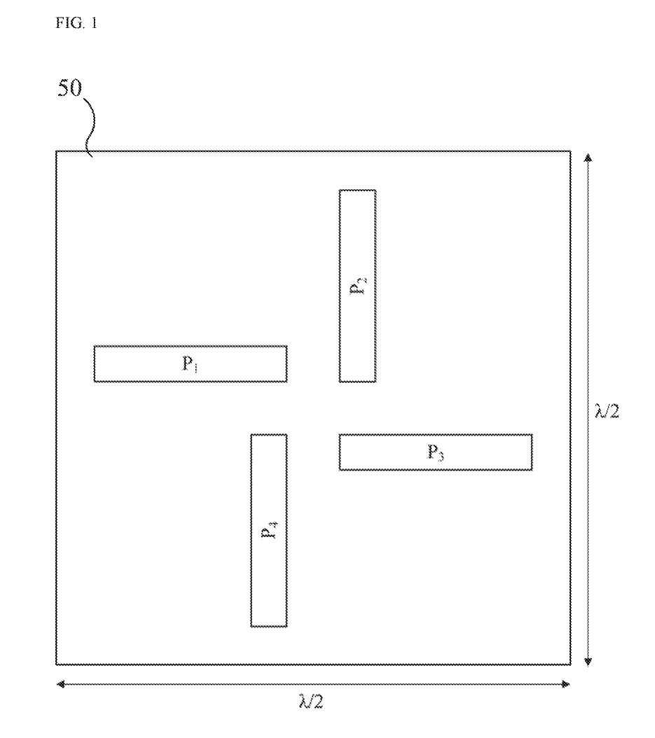

FIG. 1 shows an example of a conventional 4-port integrated antenna 50. The antenna 50 includes a plurality of antenna units P₁, P₂, P₃, and P₄. The antenna 50 is provided in a form in which the antenna units P₁, P₂, P₃, and P₄ with a general deviation angle are each rotated at an interval of 90 degrees. The antenna units P₁ and P₃ are antennae having substantially the same or similar polarization characteristics (for example, each of the antennae P₁, P₃ is a V-pol antenna), and the antenna units P₂ and P₄ are antennae having substantially the same or similar polarization characteristics (for example, each of the antennae P₂, P₄ is an H-pol antenna). In the case of having the integration structure of the antenna 50, antenna units having an interval of 90 degrees (for example, P₁ and P₂) have a low correlation level, but antenna units having an interval of 180 degrees (for example, P₁ and P₃) have a high correlation level due to the polarization component. Here, the term level of correlation level refers to a correlation level of radiation patterns output (formed) by antennae. Antenna units having a high level of correlation (for example, P₁ and P₃ antenna units) cause the rank of a channel matrix to be reduced. Accordingly, the antenna 50 having such an antenna unit does not ensure independence between signals, thus having causing difficulty in obtaining a multiple gain.

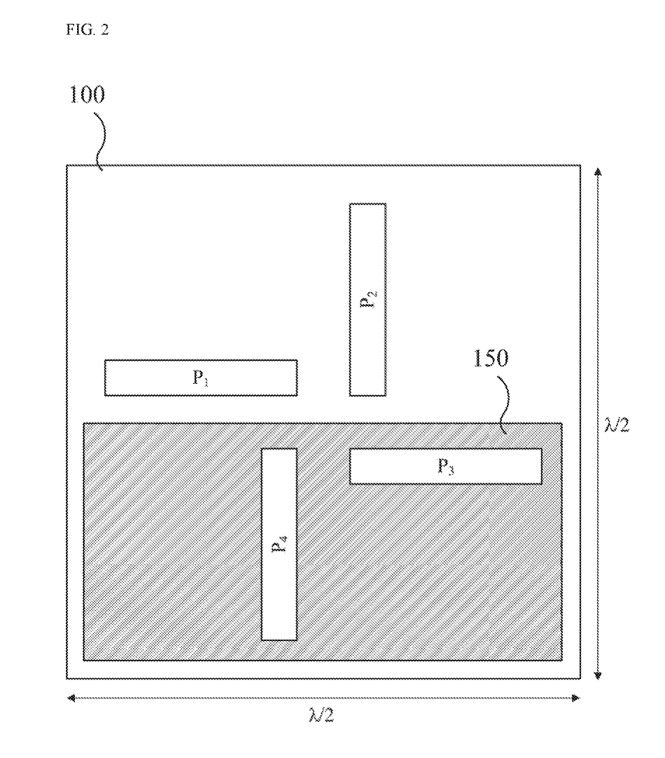

FIG. 2 provides an example of a 4-port integrated antenna 100 including a lens structure. The antenna 100 includes a plurality of antenna units P₁, P₂, P₃, and P₄. The antenna 100 is generally a 4-port integrated antenna having a structure similar to that shown in FIG. 1.

In addition, the antenna 100 includes a lens structure 150. The lens structure 150 is made of a dielectric having a specific permittivity. The lens structure 150 is preferably made of a dielectric having at least one of a permittivity and permeability greater than or equal to a certain value. The lens structure 150 may be dimensioned in a variety of shapes. In one specific example, the lens structure 150 may have a planar shape (such as a substrate) with a constant thickness. For the sake of convenience of description, the antenna that includes a lens structure will be referred to and defined as a lens antenna. The antenna units P₁, P₂, P₃, and P₄ emit electromagnetic waves. The electromagnetic waves emitted by the antenna units pass through the lens structure 150. The antenna 100 has a structure in which electromagnetic waves emitted by only some antenna units P₃ and P₄ pass through the lens structure 150. The lens structure 150 is disposed at a position, in which only electromagnetic waves emitted by the antenna units P₃ and P₄ pass through the lens structure 150.

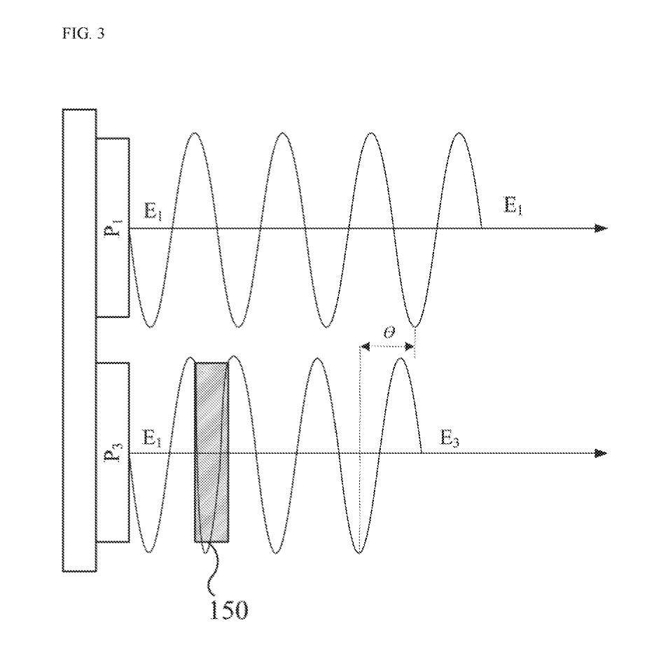

FIG. 3 shows an example of electromagnetic waves passing through a lens. FIG. 3 illustrates an example of electromagnetic waves emitted by the antenna units P₁ and P₃ in the antenna 100. It is assumed that the antenna units P₁ and P₃ generally output (emit) electromagnetic waves E₁ with the same radiation pattern.

Since an electromagnetic wave signal is generally represented by a complex number or numbers, the signal transmitted through the lens contains not only a magnitude but also phase information. When phase information is changed, an envelope correlation coefficient p (defined as a correlation level between antenna radiation patterns in Equation 1) has a reduced numerator thereof, and thus the degree of antenna correlation is reduced. As a result, the rank of a channel matrix H including interference between antennae is improved, and thus the channel capacity is improved.

$$ρ = \frac{\vert \int \int \overline{{F}_{1}} \cdot \overline{{F}_{2}^{*}} d Ω {\vert}^{2}}{\int \int \vert \overline{{F}_{1}} {\vert}^{2} d Ω \cdot \int \int \vert \overline{{F}_{2}} {\vert}^{2} d Ω} \qquad [ Equation 1 ]$$

The antenna unit P₁ outputs or emits an electromagnetic wave having a wavelength di, and the antenna unit P₃ also outputs an electromagnetic wave having the wavelength d₁. When the lens structure 150 is disposed in front of the antenna unit P₃ and when the losses on propagation of the electromagnetic wave through the lens are ignored, a signal of an electromagnetic wave generated by the antenna unit P₃ is affected by the thickness of the lens structure 150, and phase information of the electromagnetic wave is changed. The electromagnetic wave output by the antenna unit P₃ slows down during propagation through in the lens structure 150. Accordingly, the electromagnetic wave E₃ that has passed through the lens structure 150 has a constant phase difference 0 when compared to the electromagnetic wave E₁ emitted by the antenna unit P₁. In this manner, the antenna 100 reduces the level of correlation between the antenna units (for example, P₁ and P₃) when the lens structure 150 is used, thereby increasing the channel capacity.

Referring to the example shown in FIG. 2, when the thickness of the lens structure 150 having a constant permittivity in the antenna 100 varies, the correlation level between the radiation patterns emitted by the antenna units (for example, P₁ and

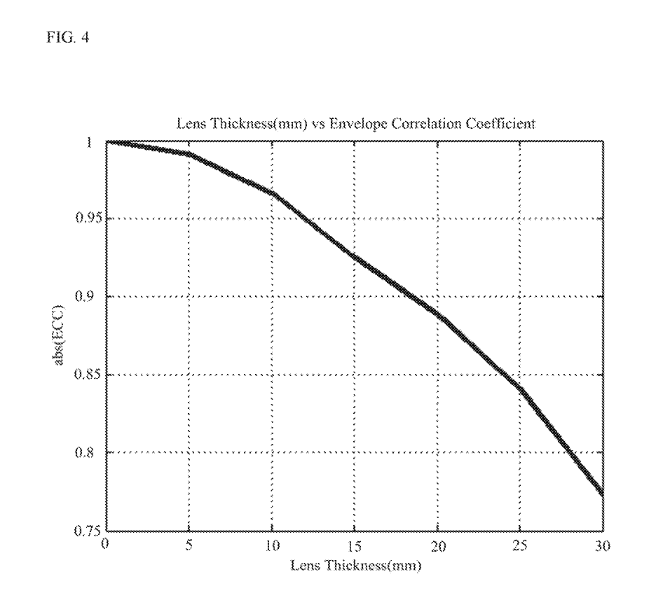

P₃) is also varied. FIG. 4 shows an example of a graph showing a relationship between the thickness of the lens structure 150 and a correlation level of radiation patterns. As the thickness of the lens structure 150 becomes thicker, the effect of a decrease in correlation level becomes larger. This is because a greater thickness of the lens structure 150 causes a larger degree of change in phase information of electromagnetic waves passing through the lens structure 150.

FIG. 4 is an example of a graph showing a relationship between the thickness of the lens structure 150 and a decrease in correlation level.

The material forming the lens structure 150 affects a correlation level of radiation patterns. For example, when the refractive index of a dielectric forming the lens structure 150 increases, the correlation level of the radiation patterns decreases in proportion to the increasing refractive index. To summarize, the material and thickness of the lens structure 150 has an influence on decreasing the degree of radiation pattern correlation.

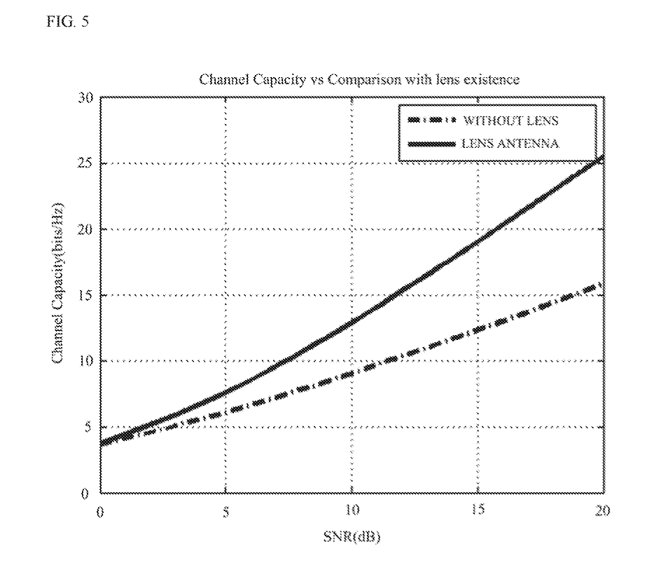

FIG. 5 shows an example of a graph showing channel capacity of a 4-port integrated antenna including a lens structure. FIG. 5 illustrates the extent to which channel capacity is increased by decreasing a correlation level. The simulation is obtained under the assumption of full scattering and non-line-of-sight (NLOS) environments. The total channel matrix H is expressed as Equation 2 below.

H=Rₜ^{1/2}H_{w}R₁^{1/2} [Equation 2]

When a correlation matrix element R_{t,(ij)}=p₍ᵢⱼ₎, matrices Rₜ and Rᵣ contribute to the improvement of the rank of the total channel H, separately from an environment channel matrix of a system Hw. Even though the effectiveness is slightly reduced in a line-of-sight (LOS) environment, a change in a phase caused by the lens structure improves the independence between antenna signals, such that the ranks of the matrices Rₜ and Rᵣ are improved and the channel capacity is increased.

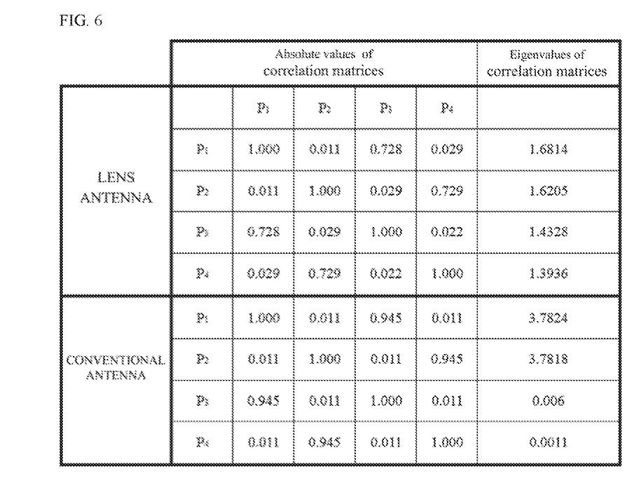

FIG. 6 shows an example of a table for analyzing a correlation level of a 4-port integrated antenna including a lens structure. FIG. 6 shows an example in which the correlation level of the antenna including the lens structure and the correlation level of a conventional antenna are analyzed. It is assumed that the lens antenna uses a FR-4 substrate having a thickness of 3 cm as a lens. FIG. 6 shows absolute values of the correlation matrices of the conventional antenna and the lens antenna. FIG. 6 also shows eigenvalues obtained by performing a singular value decomposition on the correlation matrices. Referring to FIG. 6, it can be seen that the correlation level of the lens antenna is significantly lower than that of the conventional antenna.

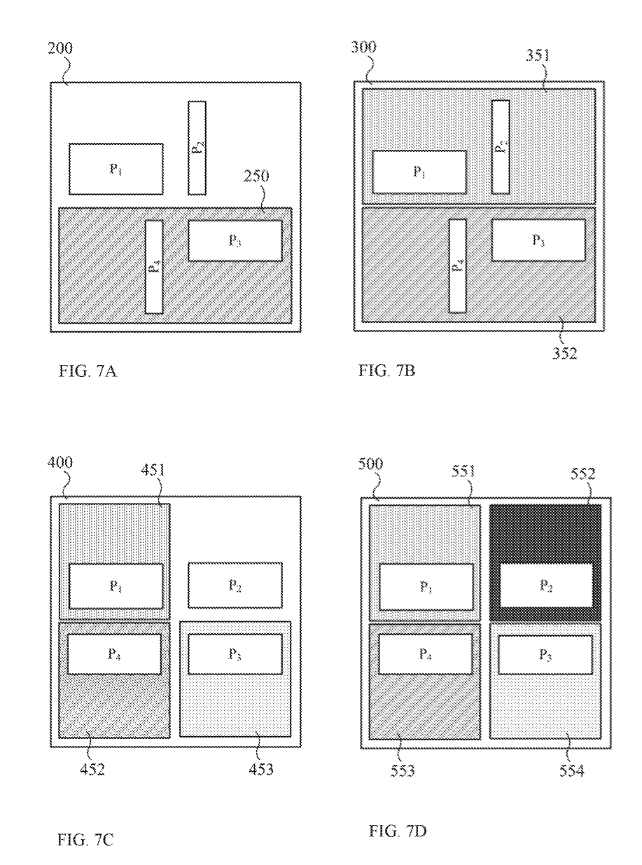

The lens antenna changes phase information of electromagnetic waves output by the antenna unit by using the lens structure. Accordingly, the channel capacity of the integrated antenna is increased. The channel capacity is increased in two aspects. One is the addition of a channel by varying radiation patterns emitted by a plurality of antenna units. The other one is the expansion of a channel by reducing interference between electromagnetic waves emitted by a plurality of antenna units. FIGS. 7A, 7B, 7C, and 7D show examples illustrating a structure of a lens antenna. An antenna 200 shown in FIG. 7A includes four antenna units P₁, P₂, P₃, and P₄ and a lens structure 250. The antenna units P₁, P₂, P₃, and P₄ may be antennae of which some have the same polarization characteristics or similar polarization characteristic to each other. Alternatively, the antenna units P₁, P₂, P₃, and P₄ may be antennae of which some have the same radiation patterns or similar radiation patterns to each other. For example, the antenna units P₁ and P₃ may have the same polarization characteristic or the same radiation pattern. In addition, the antenna units P₂ and P₄ may have the same polarization characteristic or the same radiation pattern. In this case, the lens structure 250 may be used only for the antenna units P₃ and P₄. The lens structure 250 has a placement in which the lens structure 250 allows only electromagnetic waves of the antenna units P₃ and P₄ to pass therethrough. The antenna 200 with the above described structure has a correlation level reduced between the antenna units P₁ and P₃ (or the antenna units P₂ and P₄) so that the channel capacity is increased.

It is assumed that the antenna units P₁ and P₃ emit electromagnetic waves with a first radiation pattern, and the antenna units P₂ and P₄ emit electromagnetic waves with a second radiation pattern. The antenna 200 may allow a radiation pattern emitted by the antenna units P₃ and P₄ to be changed by the lens structure 250. Accordingly, the degrees of correlation of the radiation patterns of the antenna units P₁, P₂, P₃, and P₄ are lowered.

An antenna 300 shown in FIG. 7B includes four antenna units P₁, P₂, P₃, and P₄ and two lens structures 351 and 352. Similar to FIG. 2, the antenna units P₁, P₂, P₃, and P₄ may be antennae of which some have the same polarization characteristics or similar polarization characteristics to each other. Alternatively, the antenna units P₁, P₂, P₃, and P₄ may be antennae of which some have the same radiation patterns or similar radiation patterns to each other. For example, the antenna units P₁ and P₃ may have the same polarization characteristic or the same radiation pattern. In addition, the antenna units P₂ and P₄ may have the same polarization characteristic or the same radiation pattern. The lens structure 351 and 352, which are different from each other, are respectively applied to the antenna units P₁ and P₂ and the antenna units P₃ and P₄. The lens structures 351 and 352 are structures having different refractive indexes from each other. In this case, the lens structures 351 and 352 change phase information of electromagnetic waves of “P₁/P₂” and phase information of electromagnetic waves of “P₃/P₄” to be the same. Accordingly, the antenna 300 with the above described structure has a correlation level between the antenna units P₁ and P₃ (or the antenna units P₂ and P₄) reduced so that the channel capacity is increased.

An antenna 400 shown in FIG. 7C includes four antenna units P₁, P₂, P₃, and P₄ and three lens structures 451, 452, and 453. All of the antenna units P₁, P₂, P₃, and P₄ may have the same polarization characteristics or similar polarization characteristics to each other. Alternatively, all of the antenna units P₁, P₂, P₃, and P₄ may have the same radiation patterns or similar radiation patterns to each other. In the antenna 300, the lens structures 451, 452, and 453 are used for the antenna units “P₁”, “P₃,” and “P₄”, respectively. The lens structure 451, 452, and 453 are structures having different refractive indexes from each other. The lens structures 451, 452, and 453 allow phase information of an electromagnetic wave of each of the antenna units “P₁”, “P₃,” and “P₄” to be different from each other. As a result, the antenna 400 with the above described structure has reduced degrees of correlation between all of the antenna units P₁, P₂, P₃, and P_{4.}

An antenna 500 shown in FIG. 7D includes four antenna units P₁, P₂, P₃, and P₄ and four lens structures 551, 552, 553, and 554. All of the antenna units P₁, P₂, P₃, and P₄ may have the same polarization characteristics or similar polarization characteristics to each other. Alternatively, all of the antenna units P₁, P₂, P₃, and

P₄ may have the same radiation patterns or similar radiation patterns to each other. In the antenna 500, the lens structure 551, 552, 553, and 554 are used for the antenna units “P₁”, “P₂”, “P₃”, and “P₄”, respectively. The lens structures 551, 552, 553, and 554 are structures having different refractive indexes from each other. The lens structures 551, 552, 553, and 554 change phase information of an electromagnetic wave of each of the antenna units “P₁”, “P₂”, “P₃,” and “P₄” to be different from each other. As a result, the antenna 500 with the above described structure has reduced degrees of correlation between all of the antenna units P₁, P₂, P₃, and P_{4.}

As described above, the antenna 200, 300, 400, or 500 using the lens structure may minimize interference between antenna units. Accordingly, the antenna 200, 300, 400, or 500 using the lens structure may increase the channel capacity. Further, the antenna 200, 300, 400, or 500 using the lens structure may use multiple channels using radiation patterns having different characteristics from each other. When four antenna units are provided as shown in FIG. 7, four channels may be available for use. The antenna 200, 300, 400, or 500 using the lens structure may transmit a different packet on each of the four channels. Further, the antenna 200, 300, 400, or 500 using the lens structure may perform multiple-input multiple-output (MIMO) communication using the four channels. The use of the antenna 200, 300, 400, or 500 illustrated in FIG. 7 for MIMO communication enables MIMO gain to be increased by only adding the lens structure, which is considered a relatively simple component.

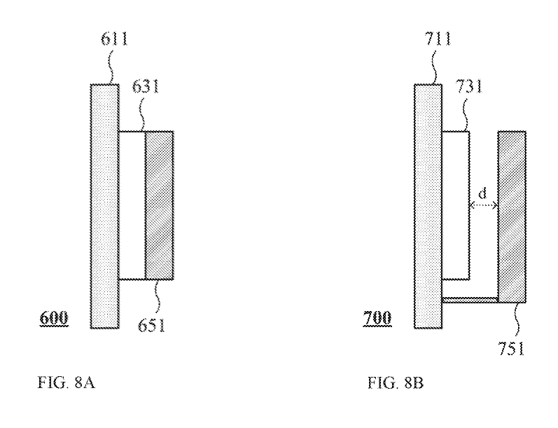

FIG. 8A, 8B show an example illustrating a placement of a lens in a lens antenna. The lens structure may have a variety of shapes. For the sake of convenience of description, it is assumed that the lens structure has a planar structure, such as a substrate. For the sake of convenience of description, a single antenna unit and a single lens structure are illustrated in FIG. 8A, 8B.

FIG. 8A shows an example illustrating the structure of a lens antenna 600. The lens antenna 600 includes a substrate 611, an antenna unit 631, and a lens structure 651. The antenna unit 631 has the form of a flat panel stacked on the substrate 611. The lens structure 651 has the form of a flat panel stacked on the antenna unit 631. The lens structure 651 may be disposed to be in contact with the antenna unit as shown in FIG. 8A.

FIG. 8B shows an example illustrating the structure of a lens antenna 700. The lens antenna 600 includes a substrate 711, an antenna unit 731, and a lens structure 751. The antenna unit 731 has the form of a flat panel stacked on the substrate 711. The lens structure 751 is disposed to be spaced a predetermined distance d from the antenna unit 731, differently from the structure shown in FIG. 8A. In order to have the antenna unit 731 spaced apart by a predetermined distance, various physical structures may be used. For example, a column-shaped structure may support the lens structure 751 as shown in FIG. 8B.

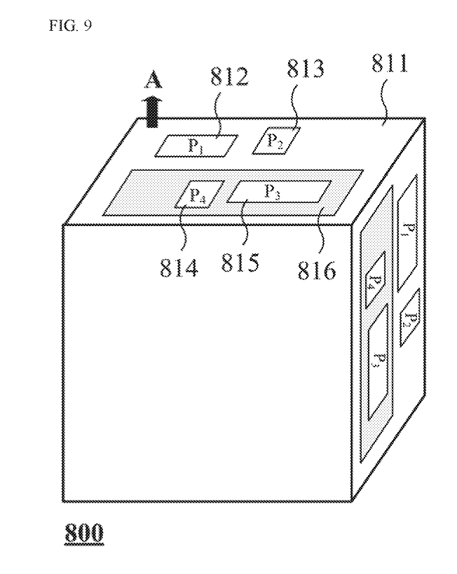

Meanwhile, the antenna may have a three-dimensional structure rather than a two-dimensional structure. FIG. 9 shows an example illustrating a placement of a lens in a lens antenna 800. FIG. 9 shows an example of a three-dimensional antenna. The lens antenna 800 includes a plurality of surfaces. One surface A has a lens antenna structure similar to that shown in FIG. 7A. For example, antenna units P₁ and P₃, i.e., 812 and 815, may have the same polarization characteristic or the same radiation pattern. In addition, antenna units P₂ and P₄, i.e., 813 and 814, may have the same polarization characteristic or the same radiation pattern. In this case, a lens structure 816 may be used only for the antenna units P₃ and P₄, i.e., 815 and 814. The lens structure 816 has a placement in which the lens structure 816 allows only electromagnetic waves of the antenna units P₃ and P₄, i.e., 815 and 814, to pass therethrough. For the sake of convenience of description, reference numbers are marked only for the antenna structure on one surface of the lens antenna 800 in FIG. 9.

In addition, an antenna structure similar to the above structure may be provided in another one of the plurality of surfaces of the lens antenna 800, differently from FIG. 9. Meanwhile, the lens antenna 800 may have the same structures or similar structures on other surfaces of the lens antenna 800. For example, the lens antenna 800 may be provided with an antenna having the same structure on each surface thereof. In addition, in order to remove interference additionally occurring due to the three-dimensional structure, the lens antenna 800 may use a lens structure in any one of a plurality of antennae in which interference occurs to a large degree.

An antenna having a lens structure has been described. The above-described lens antenna remarkably increases the channel capacity in an environment having a high MIMO gain (non-line-of-sight (NLOS), high scattering ratio). The lens antenna increases the channel capacity through a simple structure, that is, a lens structure. The lens antenna allows signals to be distinguished on the basis of phase information of a radiation pattern of an antenna unit. Accordingly, the above described lens antenna enables integration of antennae with a low correlation level, without changing physical properties, such as the direction of a radiation pattern or the intensity of a signal.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An antenna apparatus including a lens, the antenna apparatus comprising:
a plurality of antenna units; and
a lens structure configured to change a phase of an electromagnetic wave emitted by at least one antenna unit of the plurality of antenna units,
wherein the lens structure is configured to change the phase such that radiation patterns of different antenna units, from the plurality of antenna units, differ from each other.

2. The antenna apparatus of claim 1, wherein the plurality of antenna units are configured to emit corresponding electromagnetic waves having the same polarizations or the same radiation patterns.

3. The antenna apparatus of claim 1, wherein the plurality of antenna units are configured to emit corresponding electromagnetic waves having different polarizations or different radiation patterns.

4. The antenna apparatus of claim 1, wherein the lens structure is attached to or spaced by a predetermined distance from the at the least one antenna unit.

5. The antenna apparatus of claim 1, wherein, a first lens structure corresponds to a first antenna unit of the plurality of antenna units, a second lens structure corresponds to second antenna unit of the plurality of antenna units, and wherein refractive indices of the first and second lens structures are different from one another.

6. A method for communication with the use of a lens antenna, the method comprising:
emitting, by each antenna units of a plurality of antenna units, a corresponding electromagnetic wave;
allowing each of the electromagnetic waves to pass through a corresponding lens structure of a plurality of lens structures; and
forming a communication channel from at least two electromagnetic waves chosen among the electromagnetic waves that have phases changed as a result of passing through corresponding lens structures,
wherein refractive indices of different lens structures, from the plurality of lens structures, differ from one another.

7. The method of claim 6, further comprising:
performing a multiple-input multiple-output (MIMO) scheme communication with the use of at least two the electromagnetic waves.

8. The method of claim 6, wherein the emitting includes emitting said electromagnetic waves having the same radiation pattern.

9. The method of claim 6, wherein the emitting includes emitting at least two electromagnetic waves that have different radiation patterns.

10. The method of claim 6, wherein a correlation level of the electromagnetic waves which are passed through the lens structure is lower than a correlation level of the electromagnetic waves which are emitted by the antenna units.

11. A method for communication with the use of a lens antenna, the method comprising:
emitting, by each of a plurality of antenna units, a corresponding initial electromagnetic wave;
transmitting some of the initial electromagnetic waves through a lens structure; and
forming a communication channel from at least two electromagnetic waves chosen among the initial electromagnetic waves and electromagnetic waves that phase of which have been changed as a result of said transmitting.

12. The method of claim 11, further comprising performing a multiple-input multiple-output (MIMO) scheme communication using the at least two electromagnetic waves.

13. The method of claim 11, wherein the forming the communication channel includes forming the communication channel from the at least two electromagnetic waves that have different radiation patterns.

14. The method of claim 11, wherein a correlation level of the at least two electromagnetic waves that have passed through the lens structure is lower than a correlation level of the at least two electromagnetic waves emitted by the antenna units.
